(19) United States
(12) Patent Application Publication
(10) Pub. No.: US 2021/0105544 A1
(43) Pub. Date: Apr. 8, 2021

(54) MEASUREMENT SOLUTION SERVICE PROVISION SYSTEM

(71) Applicant: Teclock SmartSolutions Co., Ltd., Okaya-shi, Nagano (JP)

(72) Inventor: Kentaro HARADA, Nagano (JP)

(21) Appl. No.: 16/499,986

(22) PCT Filed: Apr. 3, 2018
(86) PCT No.: PCT/JP2018/014199

§ 371 Date: Oct. 1, 2019

(30) Foreign Application Priority Data
Apr. 3, 2017 (JP) 2017-073943

(51) Int. Cl. H04Q 9/00; H04L 29/08; G16Y 10/75; G06F 3/14; G16Y 20/10

(52) U.S. Cl. CPC H04Q 9/00; H04L 67/12; G06F 16/22; G06F 3/14; G16Y 20/10; G16Y 10/75

(57) ABSTRACT

A screen of a measurement data input device includes a reference value display portion, a measurement data display portion in which a candidate of an actual measured value is displayed with a position of at least a least significant digit in a blank state, and a numerical value selection portion in which a numerical value at least corresponding to the least significant digit in a difference between a reference value and the actual measured value is displayed so as to be selectable and designatable from a numerical value display array. The input device displays a numerical value corresponding to addition of the numerical value at least corresponding to the least significant digit designated and the reference value in the digit position in the blank state in the measurement data display portion, and outputs all digits of the actual measured value.

### TECHNICAL FIELD

The present invention relates to a measurement solution service providing system, and further relates to a measurement solution service providing method.

### BACKGROUND ART

Recently, a technology referred to as Internet of Things (IoT) attracts attention. This IoT is a technology of realizing utilization of data generated from objects by making every object (sometimes referred to as a thing) accessible to the Internet with an OPEN characteristic.

The IoT technology is expected to be the fourth industrial revolution, and rapidly changes various industrial fields by connecting things to the Internet. For example, user spending in the domestic market grows at an average of 16.9%, and the domestic market in 2020 is predicted to reach 14 trillion yen. In Germany, an effort of industrie 4.0 starts, and this is an active market worldwide.

On the background of this, in the measuring instrument manufacturing industry, this year is regarded as the IoT first year, and development of a measurement system using the IoT technology is expected along with the development of infrastructure (sometimes referred to as infra. or base).

However, until now, no system has been proposed to provide a measurement solution service that meets such expectations. For example, Patent Literature 1 discloses a background art related to the IoT technology in association with a cloud computing technology. Patent Literatures 2 and 3 disclose background art regarding the cloud computing technology. Patent Literature 4 discloses one technology regarding collection of measurement (measurement) data. Furthermore, Patent Literature 5 discloses one technology regarding display of measurement data.

### RELATED ART LITERATURE

### Patent Literature

Patent Literature 1: JP 2016-522939 A
Patent Literature 2: JP 2015-534167 A
Patent Literature 3: JP 2016-224578 A
Patent Literature 4: JP 2003-272074 A
Patent Literature 5: JP 2003-90742 A

### DISCLOSURE OF THE INVENTION

### Problems to be Solved by the Invention

In further detail, when collecting measurement data in different formats transmitted from a plurality of measurement sources arranged in a distributed manner in manufacturing bases (sites) and performing aggregation analysis processing and display processing, there are following four main problems in the conventional measurement system.

(1) An increase in aggregation cost of measurement data is inevitable. In other words, it takes many man-hours to aggregate data, and an operation cost increases.

(2) There is no immediacy in displaying the analysis results of the aggregated data. As a result, there is a delay in coping with deterioration in quality, and there is a risk of quality accidents and problems.

(3) It is difficult to integrate aggregation forms and data between manufacturing bases. That is, since data aggregation and analysis are generally performed at each base, it takes a lot of man-hours and labor to integrate data.

(4) It is difficult to automate data analysis. That is, in order to automate data analysis, introduction costs of servers and dedicated software individually occur at each base.

An object of the present invention is to provide a technology that makes it possible to realize an innovative measurement solution service regarding measurement data processing in cooperation with an IoT technology and a cloud computing technology and the like.

### Means for Solving the Problems

In order to solve the above-described problems, a measurement solution service providing system according to an aspect of the present invention is provided with a plurality of IoT relay devices arranged in respective bases, each including means for collecting measurement data in different formats transmitted from a plurality of measurement sources arranged in a distributed manner in each process in a base corresponding to a manufacturing site and measuring a quality status in each process, means for converting the collected measurement data in the different formats into measurement data in a common format, and means for transmitting the measurement data in the common format via a communication network for requesting to process the converted measurement data in the common format; and a cloud computing system including means for receiving the measurement data in the common format transmitted from each of the plurality of IoT relay devices and performing accumulation processing in a hierarchical structure in a measurement database, means for performing aggregation analysis processing on the measurement data in the common format subjected to the accumulation processing for each integration target, and means for performing display processing on a result of the aggregation analysis processing of the measurement data in the common format and transmitting a display processing result to a viewer terminal in response to a display request from the viewer terminal.

In this measurement solution service providing system, at least one of the plurality of measurement sources includes a measurement data input device which displays a screen for inputting an actual measured value by a stand-alone measuring instrument as measurement data. The screen of the measurement data input device includes a reference value display portion in which a predetermined reference value is displayed, a measurement data display portion in which a candidate of the actual measured value is displayed with a position of at least a least significant digit in a blank state, and a numerical value selection portion in which a numerical value corresponding to at least a least significant digit in a difference between the reference value and the actual measured value is displayed so as to be selectable and designatable from a numerical value display array. The measurement data input device displays a numerical value corresponding to addition of the numerical value at least corresponding to the least significant digit designated by the numerical value selection portion in the screen and the reference value in the digit position in the blank state in the measurement data display portion, and transmits all digits of the actual measured value displayed in the measurement data display portion to the IoT relay device as the measurement data in the different formats upon a confirmation instruction by a measurement worker.

In a measurement solution service providing system according to another aspect of the present invention, at least one of a plurality of measurement sources includes a measurement data input device which displays a screen for inputting an actual measured value by a stand-alone measuring instrument as measurement data. The screen of the measurement data input device includes a reference value display portion in which a predetermined reference value is displayed, a measurement data display portion in which a candidate of the actual measured value is displayed with a position of at least a least significant digit in a blank state, and a numerical value selection portion in which a numerical value corresponding to a different portion between the reference value and the actual measured value is displayed so as to be selectable and designatable from a numerical value display array. The measurement data input device displays a numerical value designated by the numerical value selection portion in the screen in the digit position in the blank state in the measurement data display portion, and transmits all digits of the actual measured value displayed in the measurement data display portion to the IoT relay device as the measurement data in the different formats upon a confirmation instruction by a measurement worker.

In a measurement solution service providing system according to still another aspect of the present invention, at least one of the plurality of IoT relay devices further includes means for displaying a confirmation screen for allowing a measurement worker to confirm an occurrence situation of data loss in a wireless communication section between the measurement source and the IoT relay device when collecting the measurement data in the different formats.

In each aspect, the measurement data in the different formats have data lengths different from each other and include at least a measurement value in a measurement source as an item, and the measurement data in the common format has a predetermined data length and includes at least identification information for specifying a user of the cloud computing system, identification information for specifying the base corresponding to the manufacturing site, identification information for specifying the measurement source, the measurement value in the measurement source, and measurement time information as items determined in advance.

In each aspect, the measurement data in the common format is accumulated in the measurement database in a hierarchical structure of a logical tree form starting from the identification information for specifying the user of the cloud computing system, branching at the identification information for specifying the base corresponding to the manufacturing site and the identification information for specifying the measurement source, and ending at the measurement value in the measurement source and the measurement time information.

In each aspect, the measurement data in the common format is subjected to the aggregation analysis processing by statistical process control analysis so that graph display, data display, and monitoring display on the viewer terminal are selectively available.

In each aspect, the cloud computing system further includes means for constantly monitoring a result of the aggregation analysis processing in the monitoring display, and performing alert notification by visual display in a case of exceeding a predetermined threshold.

In each aspect, the cloud computing system further includes means for constantly monitoring a result of the aggregation analysis processing in the monitoring display, and performing preliminary alert notification by visual display in a case of exceeding an approaching threshold to a critical threshold determined in advance.

In each aspect, each of the plurality of measurement sources includes a measuring instrument, the cloud computing system is a SaaS type cloud, the IoT relay device is an IoT gateway, and the communication network is an IP network.

### Effects of the Invention

According to the disclosed technology, it is possible to accumulate the measurement data in the common format in the cloud computing system in corporation with the IoT technology and the cloud computing technology and the like and perform the aggregation analysis processing and the display processing, thereby providing the innovative measurement solution service capable of grasping the quality status in each process in the manufacturing base anytime and anywhere.

Other problems, features, and advantages will be apparent by reading the description of embodiments for implementing the invention to be described below when taken in conjunction with the drawings and claims.

### BRIEF DESCRIPTION OF THE DRAWINGS

FIG. 1 is a block diagram illustrating a configuration of a measurement solution service providing system in one embodiment;

FIG. 2 is a view for illustrating measurement data in different formats in the system in one embodiment;

FIG. 3 is a view for illustrating measurement data in a common format in the system in one embodiment;

FIG. 4 is a view for illustrating a SaaS type cloud in the system in one embodiment;

FIG. 5 is a view for illustrating a hierarchical structure of the measurement data in the common format in the system in one embodiment;

FIG. 6 is a view for illustrating a hierarchical structure of the measurement data in the common format in the system in one embodiment;

FIG. 7 is a view for illustrating processing of the SaaS type cloud in the system in one embodiment;

FIG. 8 is a view for illustrating the processing of the SaaS type cloud in the system in one embodiment;

FIG. 9 is a view for illustrating an example of monitoring display and an example of alert notification in the system in one embodiment; and

FIG. 10 is a sequence diagram for illustrating measurement solution service provision processing in the system of one embodiment.

FIG. 11 is a block diagram illustrating a configuration of a measurement solution service providing system in a first variation;

FIG. 12 is a view illustrating an example of a measuring instrument in the system of the first variation;

FIG. 13A is a view for illustrating a measurement data input screen of a measurement data input device in the system of the first variation;

FIG. 13B is a view for illustrating the measurement data input screen of the measurement data input device in the system of the first variation;

FIG. 14 is a view for illustrating measurement data input processing of the measurement data input device in the system of the first variation;

FIG. 15 is a block diagram illustrating a configuration of a measurement solution service providing system in a second variation;

FIG. 16 is a view illustrating an example of a measuring instrument in the system of the second variation; and

FIG. 17 is a view for illustrating a measurement data reception confirmation screen of an IoT relay device in the system of the second variation.

### MODE FOR CARRYING OUT THE INVENTION

Hereinafter, it is described in further detail with reference to the attached drawings. A preferred embodiment is illustrated in the drawings. However, the present invention may be implemented in many different modes and is not limited to the embodiment described in this specification.

[Measurement Solution Service Providing System]

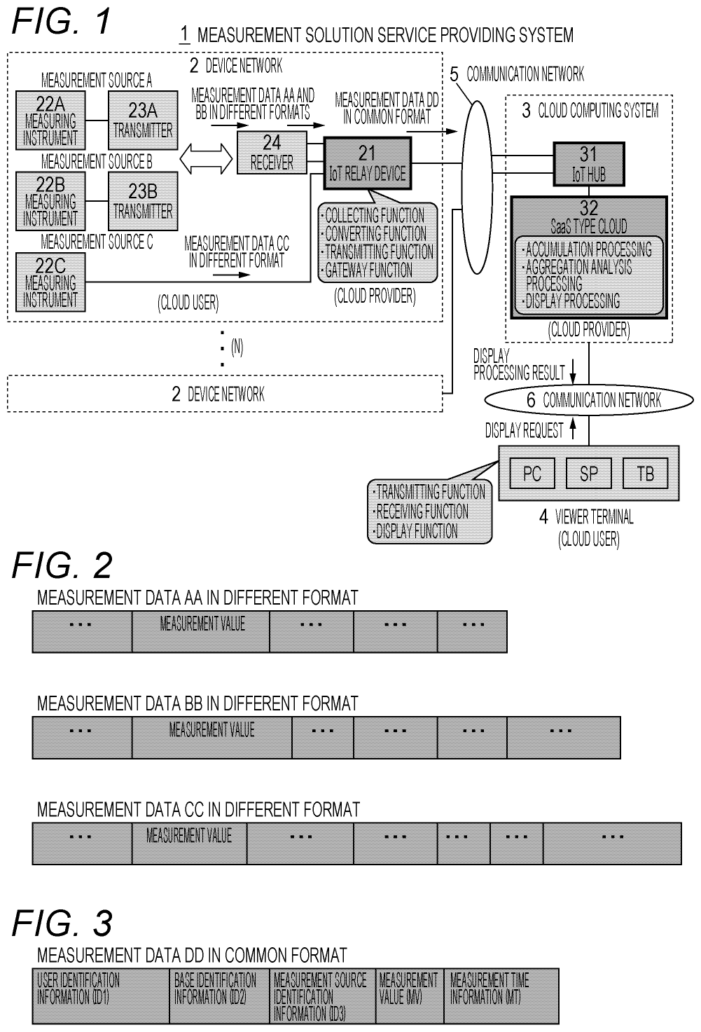

With reference to FIG. 1 illustrating a system configuration in one embodiment, a measurement solution service providing system 1 is a system which accumulates measurement data in a common format in a cloud computing system in corporation with an IoT technology and a cloud computing technology, and performs aggregation analysis processing and display processing, thereby providing an innovative measurement solution service capable of grasping a quality status in each process in a manufacturing base (site) anytime and anywhere.

The measurement solution service providing system 1 is provided with a plurality of device networks 2, a cloud computing system 3, a viewer terminal 4, a first communication network 5, and a second communication network 6. Herein, the first communication network 5 and the second communication network 6 are IP networks because the system 1 is premised on application of the IoT technology, and more specifically, the Internet having an OPEN characteristic. Note that, the communication networks 5 and 6 are sometimes the same network.

The device network 2 is a local area network (LAN) built in the manufacturing site of a contractor (a business user of a cloud) using the cloud computing system 3, that is, in a manufacturing site (manufacturing factory). There is a plurality of (N) device networks 2 built in domestic and/or overseas manufacturing sites.

Each device network 2 is provided with an IoT relay device 21, measuring instruments 22A, 22B, and 22C and wireless transmitters 23A and 23B as a plurality of measurement sources A, B, and C, and a wireless receiver 24.

The measuring instruments 22A and 22B in the plurality of measurement sources A, B, and C which are arranged in a distributed (discrete) manner in each process in the manufacturing site and measure a quality status in each process are digital measuring instruments and transmit measurement data AA and BB to the wireless receiver 24 by near field communication via the wireless transmitters 23A and 23B connected thereto. The measuring instrument 22C is an analog measuring instrument and transmits measurement data CC to the IoT relay device 21 by wired communication. The measurement data AA, BB, and CC are preferably transmitted autonomously from the plurality of measurement sources A, B, and C at predetermined intervals. Herein, the predetermined interval corresponds to a sampling time (for example, several minutes) appropriate for grasping the quality status of an object (thing) in each process in the manufacturing site.

The measurement data AA, BB, and CC transmitted from the plurality of measurement sources A, B, and C to the receiver 24 and the IoT relay deice 21 are measurement data in different formats of data lengths (for example, few to tens of bytes) different for each measurement source at least including an item of a measurement value (length, weight, hardness and the like, for example) of a measuring target different for each measurement source as illustrated in FIG. 2. Herein, the measurement value includes a measurement unit (for example, mm, g and the like), but the measurement unit may be made another item.

A reason of the measurement data in the different formats is that manufacturers of the measuring instruments 22A, 22B, and 22C and the wireless transmitters 23A and 23B are different, and types of the measuring instruments 22A, 22B, and 22C are different such as a digital measuring instrument, an analog measuring instrument, a dimension measuring instrument, a weight measuring instrument, and a hardness measuring instrument. As is described later in detail, in this measurement solution service providing system 1, conversion processing of such measurement data in different formats into measurement data in a common format is an important element of the measurement solution.

The wireless receiver 24 receives the measurement data AA and BB transmitted from the measurement sources A and B, and inputs the same in a state of the measurement data in the different formats to the IoT relay device 21.

Each IoT relay device 21 specifically is an IoT gateway provided by a cloud provider and has a function of collecting in real time the measurement data AA, BB, and CC in the different formats transmitted from the plurality of measurement sources A, B, and C arranged in each process in the manufacturing site in a distributed manner and measuring the quality status in each process, and a function of converting the collected measurement data AA, BB, and CC in the different formats into measurement data DD in the common format.

The IoT relay device 21 also has a function of transmitting the measurement data DD in the common format to the cloud computing system 3 via the first communication network 5 in order to request processing of the converted measurement data DD in the common format.

The IoT relay device 21 further has a gateway function of converting a communication protocol of the device network 2 into an Internet Protocol (IP) of the first communication network 5 when transmitting the measurement data DD in the common format to the cloud computing system 3 via the first communication network 5. In this measurement solution service providing system 1, the gateway function connects things to the Internet.

The measurement data DD in the common format is of a predetermined data length and at least includes identification information for specifying a business user of the cloud computing system 3 (user identification information) ID1, identification information for specifying a base corresponding to the manufacturing site (base identification information) ID2, identification information for specifying the measurement sources A, B, and C (measurement source identification information) ID3, measurement values MV in the measurement sources A, B, and C, and measurement time information MT in a form of year/month/day, and hour: minute as predetermined items as illustrated in FIG. 3.

Herein, the user identification information ID1, the base identification information ID2, the measurement source identification information ID3, and the measurement time information MT are added when converting the collected measurement data AA, BB, and CC in the different formats into the measurement data DD in the common format. For example, the user identification information ID1 and the base identification information ID2 are registered (stored) in advance in a memory (disk) of the IoT relay device 21 by the business user. The measurement source identification information ID3 may be generated on the basis of media access control (MAC) addresses and the like of the measurement sources A, B, and C accommodated in the IoT relay device 21. The measurement time information MT is generated on the basis of total seconds (accumulated seconds) in the IoT relay device 21 or a standard time, and strictly is information of collected (received) time.

Also, the measurement data DD in the common format to which source information SA for specifying the IoT relay device 21 and destination information DS for specifying the cloud computing system 3 are further added (not illustrated in FIG. 3) is transmitted to the cloud computing system 3 in real time in an IP packet form.

As is to be described later in detail, the measurement data DD in the common format transmitted from each IoT relay device 21 of each device network 2 and received by the cloud computing system 3 is stored (accumulated) in a hierarchical structure in a logical tree form in a measurement database of the cloud computing system 3.

The above-described IoT relay device 21 includes the following elements as a hardware configuration. That is, a central processing unit (CPU) as a processor, a random access memory (RAM) as a working memory, and a read only memory (ROM) which stores a boot program for startup are provided.

The IoT relay device 21 is also provided with a disk as a non-volatile flash memory which rewritably stores an operating system (OS), an application program, and various pieces of information (including data), a communication control unit, a communication interface unit such as a network interface card (NIC) and the like. These hardware configurations are not illustrated because one skilled in the art may easily understand and implement the same.

In order to logically realize each function described above, a processing program is installed as an application program in the flash memory. Then, in the IoT relay device 21, the processor (CPU) constantly develops this processing program in the RAM and executes the same when the power is turned on.

The cloud computing system 3 is a cloud server computer maintained and managed by the cloud provider, and is provided with an IoT hub 31 and a SaaS type cloud 32.

In the cloud computing system 3, the IoT hub 31 is connected to the plurality of (N) device networks 2 corresponding to a plurality of manufacturing sites of the business user via the first communication network 5.

Generally, cloud services provided by the cloud computing system include software as a service (SaaS), a platform as a service (PaaS), and an infrastructure as a service (IaaS).

Herein, the SaaS cloud service provides up to top application software (applications). The PaaS cloud service provides a complete platform including hardware for the application software to be operated, an operating system, and middleware. The IaaS cloud service provides an infrastructure including hardware (CPU and storage) and an operating system.

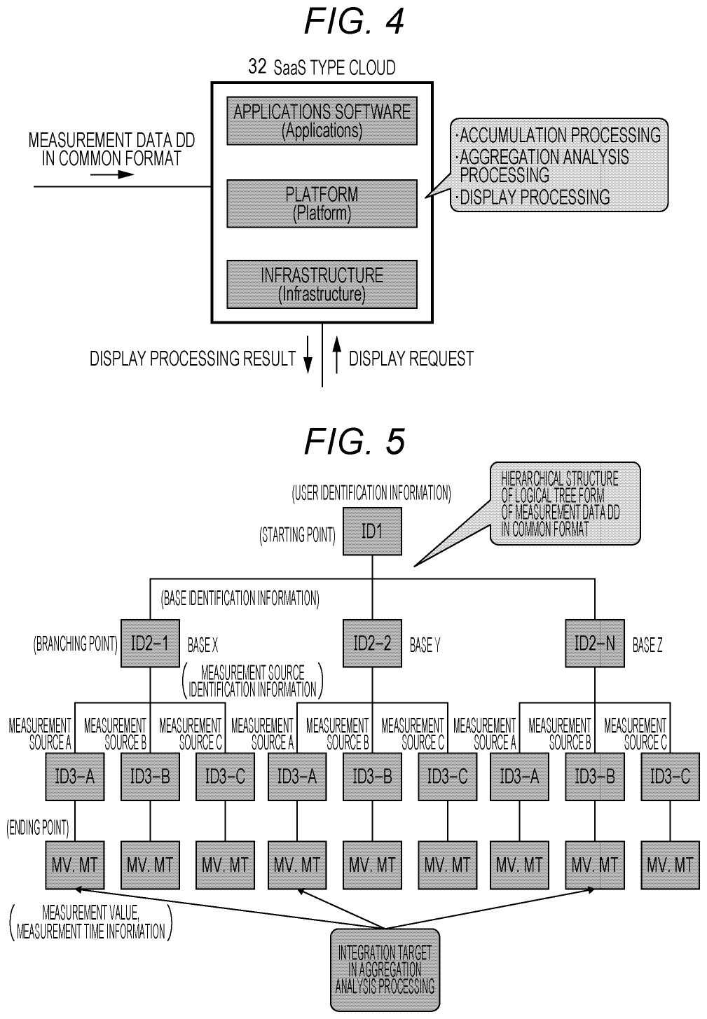

In this cloud computing system 3, the SaaS type cloud 32 is adopted as illustrated in detail in FIG. 4. The SaaS type cloud 32 receives the measurement data DD in the common format transmitted from each IoT relay device 21 in real time via the first communication network 5 and the IoT hub 31. Then, the SaaS type cloud 32 performs accumulation processing and aggregation analysis processing on the received measurement data DD in the common format.

The SaaS type cloud 32 also performs the display processing of a result of the aggregation analysis processing of the measurement data DD in the common format subjected to the accumulation processing, and when there is a display request from the viewer terminal 4, this transmits a result of the display processing to the viewer terminal 4 via the second communication network 6.

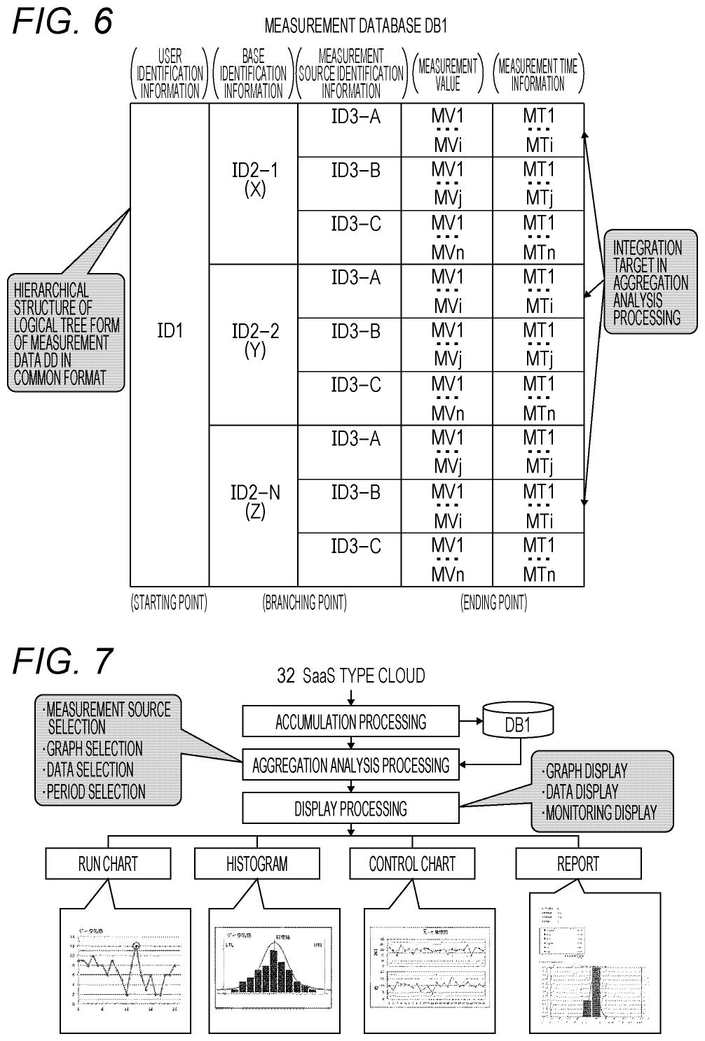

More specifically, the measurement data DD in the common format transmitted from each IoT relay device 21 of each device network 2 and received by the cloud computing system 3 is stored (accumulated) in the hierarchical structure in the logical tree form as illustrated in FIGS. 5 and 6 in the measurement database DB1 by the accumulation processing of the SaaS type cloud 32.

That is, the SaaS type cloud 32 sequentially accumulates the measurement values MV and the measurement time information MT in the measurement sources A, B, and C for each of bases X, Y, and Z corresponding to the hierarchy of the user identification information ID1—base identification information ID2—measurement source identification information ID3 in the measurement database DB1 by the accumulation processing of the received measurement data DD in the common format.

Therefore, the measurement data DD in the common format may be regarded as the hierarchical structure in the logical tree form starting from the user identification information ID1, branching at the base identification information ID2 and the measurement source identification information ID3, and ending at the measurement value MV and the measurement time information MT in the measurement database DB1.

The SaaS type cloud 32 processes the measurement values MV and the measurement time information MT in the measurement sources A, B, and C in each of the bases X, Y, and Z by statistical process control (SPC) analysis when performing the aggregation analysis processing on the measurement data DD in the common format in the measurement database DB1 subjected to the aggregation processing.

When the SaaS type cloud 32 performs the aggregation analysis processing, this integrates the measurement values MV and the measurement time information MT in the measurement sources A, B, and C of the bases X, Y, and Z and thereafter processes the same by the SPC analysis. For this integration, the SaaS type cloud 32 recognizes that the measurement values MV at the measurement sources A, B, and C of the bases X, Y, and Z are related to one another on the basis of the measurement unit included in the measurement value MV. FIG. 6 illustrates that the measurement values MV in the measurement source A in the base X (ID3-A), the measurement source A in the base Y (ID3-A), and the measurement source B in the base Z (ID3-B) are related to one another as integration targets.

Note that, in a case where the recognition on the basis of the measurement unit cannot be applied, the SaaS type cloud 32 recognizes the relation of the measurement values MV in the measurement sources A, B, and C of the bases X, Y, and Z on the basis of predetermined integration definition. In this integration definition, the measurement sources A, B, and C of the bases X, Y, and Z are set (registered) in advance in association with one another according to types of measuring instruments 22A, 22B, and 22C of the measurement sources A, B, and C in each of the bases X, Y, and Z, that is, the dimension measuring instrument, the weight measuring instrument, the hardness measuring instrument and the like.

Herein, the SPC analysis adopted by the SaaS type cloud 32 is a method of monitoring and visualizing processes using statistics and a graph. In the SPC analysis, graphs such as control charts (Xbar-R chart, Xbar-σ chart and the like), a histogram, a run chart, a boxplot, and a scatter chart, and statistics such as a process capability index Cp and a process performance index Pp may be displayed on one screen. This makes it possible to obtain a lot of pieces of quality analysis information regarding the process from one screen.

The SaaS type cloud 32 performs the aggregation analysis processing by the SPC analysis so that graph display, data display, and monitoring display of the measurement data DD in the common format accumulated in the measurement database DB1 to the viewer terminal 4, and stores the result of the aggregation analysis processing in a database (not illustrated).

The SaaS type cloud 32 displays the graphs such as the histogram, the run chart, and the control chart as a display processing result when displaying the result of the aggregation analysis processing as a graph in response to the display request from the viewer terminal 4 (refer to FIG. 7).

Also, when the SaaS type cloud 32 displays the result of the aggregation analysis processing as data in response to the display request from the viewer terminal 4, this displays the data such as an average value, a maximum value, a minimum value, standard deviation, 3σ, and the process capability index Cp as the display processing result (report) (refer to FIG. 7).

Furthermore, the SaaS type cloud 32 displays the run chart and the like as the display processing result when monitoring displaying the result of the aggregation analysis processing in response to the display request from the viewer terminal 4 (refer to FIG. 7).

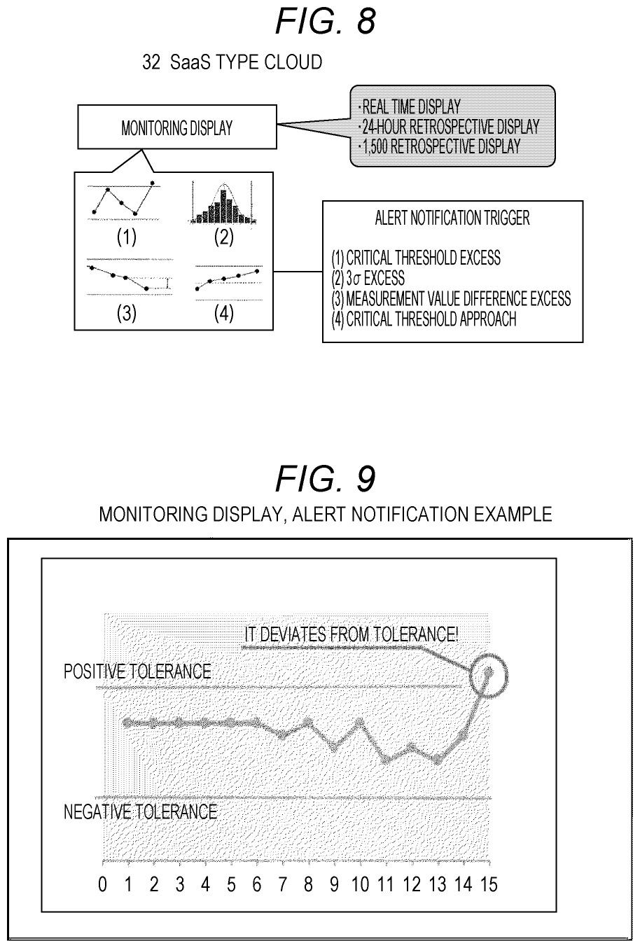

Note that the display request from the viewer terminal 4 includes designation such as measurement source selection, graph selection, data selection, and period selection. The display request regarding the monitoring display further includes designation such as real time display, 24-hour retrospective display, and 1,500 retrospective display (refer to FIGS. 7 and 8).

In the monitoring display, the SaaS type cloud 32 constantly monitors the result of the aggregation analysis processing, and in a case where this exceeds a predetermined critical threshold (for example, positive tolerance and negative tolerance), a corresponding graph display site (dot) is displayed in red, and alert notification (for example, “it deviates from tolerance!!”) is displayed by visual display (refer to FIG. 9). In this case, the SaaS type cloud 32 may display a state of the corresponding measurement source on the screen by red flashing. Note that, as a threshold of an alert notification trigger, 3σ excess, measurement value difference excess and the like may also be set.

In addition, in the monitoring display, a critical threshold approaching threshold is set as the threshold of the alert notification trigger, and the SaaS type cloud 32 constantly monitors the result of the aggregation analysis processing, and in a case where this exceeds the critical threshold approaching threshold (for example, vicinity of the positive tolerance and vicinity of the negative tolerance), preliminary alert notification (for example, “it is likely to deviate from tolerance!!”) may be displayed by visible display. In this case, the SaaS type cloud 32 may display by red display and red flashing in the above-described manner. That is, the SaaS type cloud 32 predicts in advance occurrence of process abnormality (quality abnormality) on the basis of the result of the aggregation analysis processing of the measurement data DD in the common format accumulated in the measurement database DB1.

As described above, the SaaS type cloud 32 of the cloud computing system 3 has a function of receiving the measurement data DD in the common format transmitted from each of the plurality of IoT relay devices 21 and performing the aggregation processing in the hierarchical structure in the measurement database DB1, a function of performing the aggregation analysis processing of the measurement data DD in the common format subjected to the accumulation processing for each integration target, and function of performing the display processing of the result of the aggregation analysis processing of the measurement data DD in the common format and transmitting the display processing result to the viewer terminal 4 in response to the display request from the viewer terminal 4.

In the SaaS type cloud 32, in order to logically realize each function described above, a processing program is installed as an application program in a flash memory. Then, in the SaaS type cloud 32, when the power is turned on, a processor (CPU) always develops this processing program in a RAM to execute. The measurement database DB1 and the like is formed in the flash memory, and updated while maintaining a predetermined data storage amount.

The viewer terminal 4 is a terminal such as a personal computer PC, a smartphone SP, and a tablet TB including a world wide web (Web) browser, and is used by a viewer of the business user.

The viewer terminal 4 has a function of transmitting the display request for requesting the display processing result of the measurement data DD in the common format from the cloud computing system 3 via the second communication network 6, a function of receiving the display processing result from the cloud computing system 3, and a function of displaying the received display processing results. The viewer of the business user may grasp the quality status in each process in each base on the basis of the display processing result displayed on the viewer terminal 4 and take required measures.

The hardware configuration of the viewer terminal 4 is not illustrated nor described because one skilled in the art may easily understood and implement the same. In the viewer terminal 4, in order to logically realize each function described above, a processing program is installed as an application program in a flash memory. Then, in the viewer terminal 4, when the power is turned on or upon instruction by the viewer, a processor (CPU) develops this processing program in a RAM to execute.

[Measurement Solution Service Provision Processing]

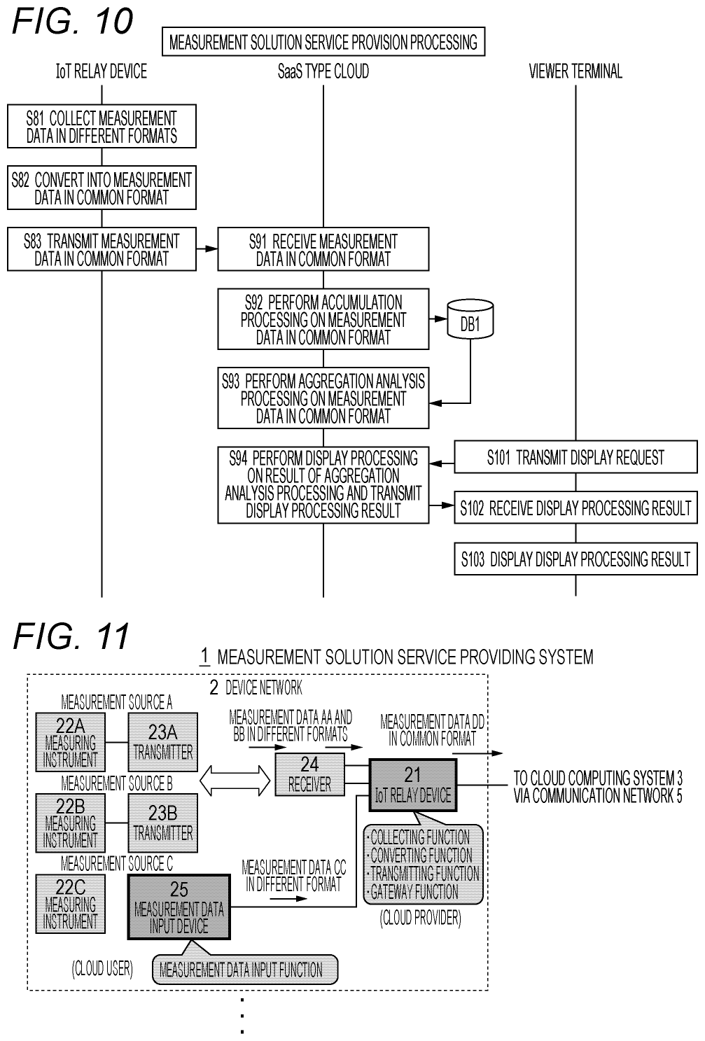

Next, operation in the measurement solution service providing system 1 described above is described with reference to FIGS. 1 and 10 and the related drawings. FIG. 10 illustrates an example of a sequence of measurement solution service provision processing in the measurement solution service providing system 1 described above. Note that, in the following description, intervention of the communication networks 5 and 6 and the IoT hub 31 is omitted unless it is unclear.

In each IoT relay device 21, the processing program is activated in response to power on, and the processor (CPU) executes the processing described below.

[Processing S81 (refer to FIG. 10)] The measurement data AA, BB, and CC in the different formats transmitted from the plurality of measurement sources A, B, and C are collected.

[Processing S82] The collected measurement data AA, BB, and CC in the different formats are converted into the measurement data DD in the common format. When converting into the measurement data DD in the common format, the user identification information ID1, the base identification information ID2, the measurement source identification information ID3, and the measurement time information MT are added.

[Processing S83] The measurement data DD in the common format is transmitted to the cloud computing system 3. When transmitting the measurement data DD in the common format, the protocol is converted into the IP protocol.

Also, in the SaaS type cloud 32 of the cloud computing system 3, the processing program is activated when the power is turned on, and the processor (CPU) executes the processing described below.

[Processing S91 (refer to FIG. 10)] The measurement data DD in the common format transmitted from each IoT relay device 21 is received.

[Processing S92] The received measurement data DD in the common format is subjected to the accumulation processing in the measurement database DB1 in the hierarchical structure.

[Processing S93] The measurement data DD in the common format subjected to the accumulation processing is subjected to the aggregation analysis processing for each integration target.

[Processing S94] The display processing of the result of the aggregation analysis processing of the measurement data DD in the common format is performed, and the display processing result is transmitted to the viewer terminal 4 in response to the display request from the viewer terminal 4.

Furthermore, in the viewer terminal 4, the processing program is activated when the power is turned on or upon the instruction by the viewer, and the processor (CPU) executes the processing described below.

[Processing S101 (refer to FIG. 10)] The display request for requesting the display processing result of the measurement data DD in the common format is transmitted to the cloud computing system 3.

[Processing S102] The display processing result is received from the cloud computing system 3.

[Processing S103] The received display processing result is displayed.

### Effect of One Embodiment

The measurement solution service providing system 1 of one embodiment described above may accumulate the measurement data DD in the common format in the cloud computing system 3 in corporation with the IoT technology and the cloud computing technology and perform the aggregation analysis processing and the display processing, thereby providing the innovative measurement solution service capable of grasping the quality status in each process in the manufacturing base (site) to the business user anytime and anywhere.

Also, in this measurement solution service providing system 1, the cloud computing system 3 processes the measurement data DD in the common format transmitted from each of the plurality of IoT relay devices 21 arranged in each base, so that it is possible to reduce a burden of the application software of the SaaS type cloud 32 and improve processing ability.

### First Variation of One Embodiment

Next, a first variation in the measurement solution service providing system 1 described above is described with reference to FIGS. 11, 12, 13A, 13B, and 14.

In the measurement solution service providing system 1 of one embodiment described above, the measuring instruments 22A and 22B in a plurality of measurement sources A, B, and C which are arranged in a distributed manner in each process in the manufacturing site and measure a quality status in each process are digital measuring instruments and transmit the measurement data AA and BB to the wireless receiver 24 by near field communication via the wireless transmitters 23A and 23B connected thereto. The wireless receiver 24 receives the measurement data AA and BB transmitted from the measurement sources A and B, and inputs the same in a state of the measurement data in the different formats to the IoT relay device 21. In addition, it is described that the measuring instrument 22C in the plurality of measurement sources A, B, and C is an analog measuring instrument and transmits the measurement data CC to the IoT relay device 21 by wired communication.

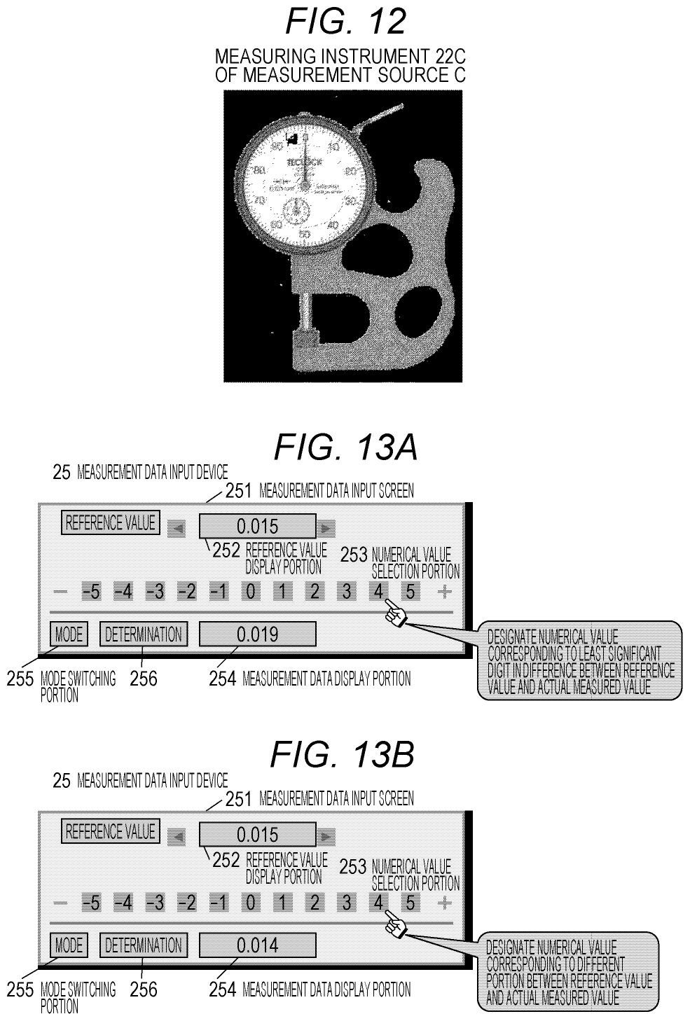

In a measurement solution service providing system 1 of the first variation illustrated in FIG. 11, a measuring instrument 22C of a measurement source C in a device network 2 is a stand-alone analog measuring instrument (for example, a two-needle dial gauge illustrated in FIG. 12), and the measurement source C has a configuration including a measurement data input device 25 in order to transmit measurement data CC to an IoT relay device 21 by wired communication.

The measurement data input device 25 is formed of a personal computer, a smartphone, a tablet terminal or the like, and is at least provided with a processing program for performing a measurement data input function to be described later in detail from a cloud provider, so that this is used by a measurement worker of a business user.

When the measurement worker measures a dimension of a part, for example, at predetermined intervals by the stand-alone measuring instrument 22C and transmits the input measurement data CC, a measurement data input screen 251 an example of which is illustrated in FIG. 13A or 13B is displayed on the measurement data input device 25. The measurement data input screen 251 includes a reference value display portion 252, a numerical value selection portion 253, a measurement data display portion 254, a mode switching portion 255 and the like.

With reference to FIG. 13A, when the measurement worker designates a first mode by a mode button of the mode switching portion 255 and inputs the measurement data CC measured by the measuring instrument 22C, a predetermined reference value (for example, 0.015) is displayed in the reference value display portion 252 on the measurement data input screen 251. This reference value indicates a reference (target value) of the dimension (unit: mm) of the part measured in a process corresponding to the measurement source C, and is registered (stored) in advance in a memory of the measurement data input device 25 by the measurement worker by operation of a numeric keypad or the like.

In addition, 0.01X is displayed in the measurement data display portion 254 as a candidate of an actual measured value. Here, a least significant digit position corresponding to “X” in 0.01X is displayed by a blinking cursor in a blank state. When the actual measured value is, for example, 0.019, the measurement worker selects to designate a numerical value “4” corresponding to the least significant digit in a difference (0.004) between the reference value (0.015) and the actual measured value (0.019) from a numerical value display array in the numerical value selection portion 253. As a result, a numerical value corresponding to addition of the numerical value corresponding to the least significant digit designated by the numerical value selection portion 253 and the reference value is displayed in the digit position in the blank state in the measurement data display portion 254, so that the measurement data 0.019 corresponding to all digits of the actual measured value is displayed in the measurement data display portion 254.

When the measurement worker confirms the measurement data displayed in the measurement data display portion 254 and designates a determination button 256, the measurement data input device 25 transmits the measurement data 0.019 displayed in the measurement data display portion 254 to the IoT relay device 21 by wired communication as the measurement data CC in a different format.

The IoT relay device 21 transmits measurement data DD in a common format to a cloud computing system 3 via a first communication network 5 in order to request processing of the converted measurement data DD in the common format as in one embodiment describe above.

The first mode enables the measurement worker to select the numerical value corresponding to the least significant digit in the difference between the reference value and the actual measured value from the numerical value display array in the numerical value selection portion 253 and input the same in a limited manner.

Subsequently, with reference to FIG. 13B, when the measurement worker designates a second mode by the mode button of the mode switching portion 255 and inputs the measurement data CC measured by the measuring instrument 22C, a predetermined reference value (for example, 0.015) is displayed on the reference value display portion 252 in the measurement data input screen 251. This reference value indicates a reference (target value) of the dimension (unit: mm) of the part measured in a process corresponding to the measurement source C, and is registered (stored) in advance in a memory of the measurement data input device 25 by the measurement worker by operation of a numeric keypad or the like.

In addition, 0.01X is displayed in the measurement data display portion 254 as a candidate of an actual measured value. Here, a least significant digit position corresponding to “X” in 0.01X is displayed by a blinking cursor in a blank state. When the actual measured value is, for example, 0.014, the measurement worker selects to designate a numerical value “4” corresponding to a different portion between the reference value (0.015) and the actual measured value (0.014) from a numerical value display array in the numerical value selection portion 253. As a result, the numerical value designated in the numerical value selection portion 253 is displayed in the digit position in the blank state in the measurement data display portion 254, so that the measurement data 0.014 corresponding to all digits of the actual measured value is displayed in the measurement data display portion 254.

When the measurement worker confirms the measurement data displayed in the measurement data display portion 254 and designates the determination button 256, the measurement data input device 25 transmits the measurement data 0.014 displayed in the measurement data display portion 254 to the IoT relay device 21 by wired communication as the measurement data CC in a different format.

The IoT relay device 21 transmits measurement data DD in a common format to a cloud computing system 3 via a first communication network 5 in order to request processing of the converted measurement data DD in the common format as in one embodiment describe above.

The second mode enables the measurement worker to select the numerical value corresponding to the different portion between the reference value and the actual measured value from the numerical value display array in the numerical value selection portion 253 and directly input the same in a limited manner.

Note that, in the first mode and the second mode of the measurement data input function described above, the numerical value corresponding to the least significant digit in the difference between the predetermined reference value and the actual measured value and the numerical value corresponding to the least significant digit which is the different portion between the predetermined reference value and the actual measured value may be selected from the numerical value display array in the numerical value selection portion 253, respectively, and may be input in a limited manner; however, it is also possible to select to input numerical values corresponding to a plurality of least significant digits by moving operation of the blinking cursor.

A hardware configuration of the above-described measurement data input device 25 is not illustrated nor described because one skilled in the art may easily understood and implement the same. In the measurement data input device 25, in order to logically realize the measurement data input function described above, a measurement data input processing program is installed as an application program in a flash memory. Then, in the measurement data input device 25, when the power is turned on or upon instruction by the measurement worker, a processor (CPU) develops this processing program in a RAM to execute.

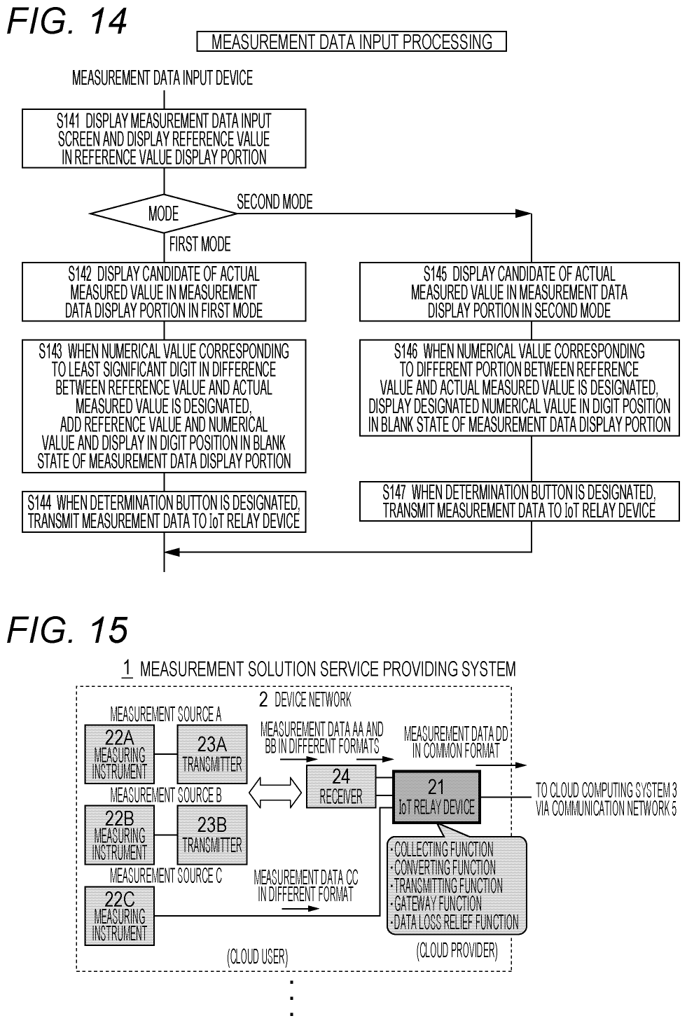

That is, in the measurement data input device 25, the processing program is activated when the power is turned on or upon the instruction by the measurement worker, and the processor executes measurement data input processing described below.

[Processing S141 (refer to FIG. 14)] The measurement data input screen 251 is displayed, and the reference value (for example, 0.015) stored in advance in the memory is read and displayed in the reference value display portion 252.

[Processing S142] When the measurement worker designates the first mode by the mode button of the mode switching portion 255, 0.01X is displayed in the measurement data display portion 254 as the candidate of the actual measured value. Here, the least significant digit position corresponding to “X” in 0.01X is displayed by the blinking cursor in the blank state.

[Processing S143] When the measurement worker selects to designate the numerical value “4” corresponding to the least significant digit in the difference (0.004) between the reference value (0.015) and the actual measured value (0.019) from the numerical value display array in the numerical value selection portion 253, the reference value (0.015) and the numerical value “4” corresponding to the least significant digit are added and displayed in the digit position in the blank state in the measurement data display portion 254, and the measurement data 0.019 corresponding to all the digits of the actual measured value is displayed in the measurement data display portion 254.

[Processing S144] When the measurement worker designates the determination button 256, the measurement data 0.019 mm is transmitted as the measurement data CC to the IoT relay device 21 by the wired communication.

[Processing S145] Also, when the measurement worker designates the second mode by the mode button of the mode switching portion 255, 0.01X is displayed in the measurement data display portion 254 as the candidate of the actual measured value. Here, the least significant digit position corresponding to “X” in 0.01X is displayed by the blinking cursor in the blank state.

[Processing S146] When the measurement worker selects to designate the numerical value “4” corresponding to the different portion between the reference value (0.015) and the actual measured value (0.014) from the numerical value display array in the numerical value selection portion 253, the designated numerical value “4” is displayed in the digit position in the blank state in the measurement data display portion 254, and the measurement data 0.014 corresponding to all the digits of the actual measured value is displayed in the measurement data display portion 254.

[Processing S147] When the measurement worker designates the determination button 256, the measurement data 0.014 mm is transmitted as the measurement data CC to the IoT relay device 21 by the wired communication.

In the measurement solution service providing system 1 of the first variation described above, even in a case where the measurement source C including the stand-alone measuring instrument 22C is present in the device network 2, the measurement data input device 25 transmits the measurement data CC from the measurement source C to the IoT relay device 21, so that it is possible to reflect the same in the measurement solution service provided by the cloud computing system 3.

The first variation described above is also applicable to a measurement solution service providing system 1 of a second variation to be described later in detail.

### Second Variation of One Embodiment

Next, a second variation in the measurement solution service providing system 1 described above is described with reference to FIGS. 15, 16, and 17.

In the measurement solution service providing system 1 of one embodiment described above, the measuring instruments 22A and 22B in a plurality of measurement sources A, B, and C which are arranged in a distributed manner in each process in the manufacturing site and measure a quality status in each process are digital measuring instruments and transmit the measurement data AA and BB to the wireless receiver 24 by near field communication via the wireless transmitters 23A and 23B connected thereto. The wireless receiver 24 receives the measurement data AA and BB transmitted from the measurement sources A and B, and inputs the same in a state of the measurement data in the different formats to the IoT relay device 21. In addition, it is described that the measuring instrument 22C in the plurality of measurement sources A, B, and C is an analog measuring instrument and transmits the measurement data CC to the IoT relay device 21 by wired communication.

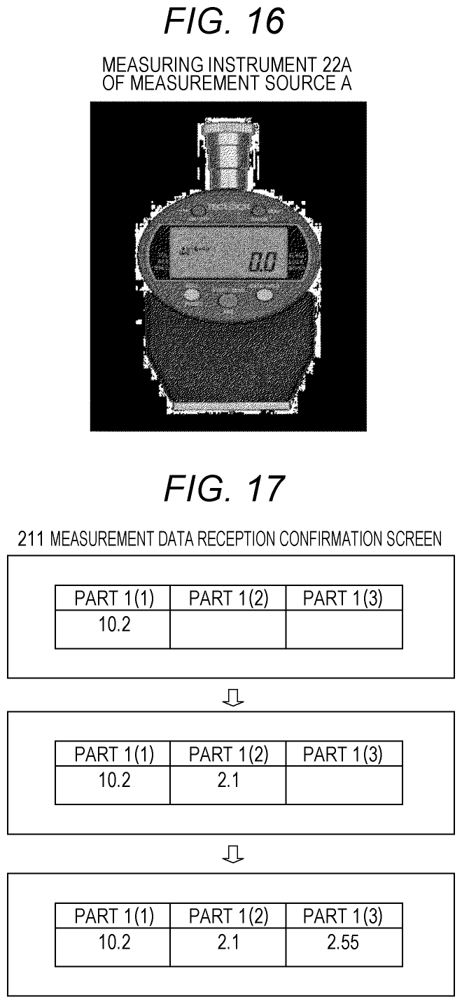

In a measurement solution service providing system 1 of the second variation illustrated in FIG. 15, measuring instruments 22A and 22B in a plurality of measurement sources A, B, and C are digital measuring instruments (for example, gauges illustrated in FIG. 16) and transmit measurement data AA and BB to a wireless receiver 24 by near field communication via wireless transmitters 23A and 23B connected thereto. However, in a wireless communication section between the wireless transmitters 23A and 23B and the wireless receiver 24, the measurement data AA and BB might be lost due to an influence of an environment in a manufacturing site and the like. An IoT relay device 21 arranged in each base corresponding to the manufacturing site further includes a data loss relief function for saving such loss of the measurement data.

When the IoT relay device 21 collects the measurement data AA in a different format transmitted from the wireless transmitter 23A of the measurement source A via the wireless receiver 24 (refer to processing S81 in FIG. 10), for example, it is set in advance to display the received measurement data AA on a measurement data reception confirmation screen 211 (refer to FIG. 17) as the data loss relief function.

Also, when the IoT relay device 21 collects the measurement data AA, in a case where the measurement data AA cannot be received at predetermined intervals, it is set in advance, as the data loss relief function, to display a communication abnormality message (for example, “timeout occurs”) on the measurement data reception confirmation screen 211 to notify the measurement worker that the data loss occurs in the wireless communication section between the measurement source A and the IoT relay device 21.

The measurement worker may recognize normal reception of the measurement data AA in the IoT relay device 21 by confirming that the communication abnormality message is not displayed on the measurement data reception confirmation screen 211. On the other hand, when the communication abnormality message is displayed on the measurement data reception confirmation screen 211, the measurement worker determines that the data loss occurs, and operates a re-measurement button of the measuring instrument 22A to perform the measurement again.

In the measurement data reception confirmation screen 211 illustrated in FIG. 17, a state transition in which dimension measurement is performed at three sites of the same part by the measuring instrument 22A of the measurement source A, and this is transmitted from the measurement source A to the IoT relay device 21 as measurement data AA is illustrated; however, it is also possible that the dimension measurement is performed at one site.

In the measurement solution service providing system 1 of the second variation described above, even in a case where there is the wireless communication section between the measurement source and the IoT relay device 21 and the data loss occurs, the measurement data from the measurement source is made transmittable to the IoT relay device 21 again, so that it is possible to reflect the same in the measurement solution service provided by the cloud computing system 3.

The second variation described above is also applicable to the measurement solution service providing system 1 of the first variation illustrated in FIG. 11.

[Other Variation]

The processing in one embodiment and the first and second variations described above is provided as a computer-executable program, and may be provided via a non-transitory computer-readable recording medium such as a CD-ROM or a flexible disk, and further via a communication line.

In addition, a plurality of or all of the processes in one embodiment and the first and second variations described above may be selected and combined to be implemented.

### DESCRIPTION OF THE REFERENCE NUMERALS

1 measurement solution service providing system
2 device network
3 cloud computing system
4 viewer terminal
5 first communication network
6 second communication network
21 IoT relay device
22A measuring instrument
22B measuring instrument
22C measuring instrument
23A wireless transmitter
23B wireless transmitter
24 wireless receiver
25 measurement data input device
31 IoT hub
32 SaaS type cloud
DB1 measurement database
251 measurement data input screen
211 measurement data reception confirmation screen

1. A measurement solution service providing system comprising:
a plurality of IoT relay devices arranged in respective bases, each configured to:
collect measurement data in different formats transmitted from a plurality of measurement sources arranged in a distributed manner in each process in a base corresponding to a manufacturing site and measuring a quality status in each process,
convert the collected measurement data in the different formats into measurement data in a common format, and
transmit the measurement data in the common format via a communication network for requesting to process the converted measurement data in the common format, and
a cloud computing system configured to:
receive the measurement data in the common format transmitted from each of the plurality of IoT relay devices and performing accumulation processing in a hierarchical structure in a measurement database,
perform aggregation analysis processing on the measurement data in the common format subjected to the accumulation processing for each integration target, and
perform display processing on a result of the aggregation analysis processing of the measurement data in the common format and transmitting a display processing result to a viewer terminal in response to a display request from the viewer terminal,
wherein at least one of the plurality of measurement sources includes a measurement data input device displaying a screen for inputting an actual measured value by a stand-alone measuring instrument as measurement data;
the screen of the measurement data input device includes:
a reference value display portion in which a predetermined reference value is displayed,
a measurement data display portion in which a candidate of the actual measured value is displayed with a position of at least a least significant digit in a blank state, and
a numerical value selection portion in which a numerical value at least corresponding to the least significant digit in a difference between the reference value and the actual measured value is displayed so as to be selectable and designatable from a numerical value display array, and
the measurement data input device includes a processor configured to:
display a numerical value corresponding to addition of the numerical value at least corresponding to the least significant digit designated by the numerical value selection portion in the screen and the reference value in the digit position in the blank state in the measurement data display portion, and
transmit all digits of the actual measured value displayed in the measurement data display portion to the IoT relay device as the measurement data in the different formats upon a confirmation instruction by a measurement worker.

2. A measurement solution service providing system comprising:
a plurality of IoT relay devices arranged in respective bases, each configured to:
collect measurement data in different formats transmitted from a plurality of measurement sources arranged in a distributed manner in each process in a base corresponding to a manufacturing site and measuring a quality status in each process,
convert the collected measurement data in the different formats into measurement data in a common format, and
transmit the measurement data in the common format via a communication network for requesting to process the converted measurement data in the common format, and
a cloud computing system configured to:
receive the measurement data in the common format transmitted from each of the plurality of IoT relay devices and performing accumulation processing in a hierarchical structure in a measurement database,
perform aggregation analysis processing on the measurement data in the common format subjected to the accumulation processing for each integration target, and
perform display processing on a result of the aggregation analysis processing of the measurement data in the common format and transmitting a display processing result to a viewer terminal in response to a display request from the viewer terminal,
wherein at least one of the plurality of measurement sources includes a measurement data input device displaying a screen for inputting an actual measured value by a stand-alone measuring instrument as measurement data;
the screen of the measurement data input device includes:
a reference value display portion in which a predetermined reference value is displayed,
a measurement data display portion in which a candidate of the actual measured value is displayed with a position of at least a least significant digit in a blank state, and
a numerical value selection portion in which a numerical value corresponding to a different portion between the reference value and the actual measured value is displayed so as to be selectable and designatable from a numerical value display array, and
the measurement data input device includes a processor configured to:
display a numerical value designated by the numerical value selection portion in the screen in the digit position in the blank state in the measurement data display portion, and
display all digits of the actual measured value displayed in the measurement data display portion to the IoT relay device as the measurement data in the different formats upon a confirmation instruction by a measurement worker.

3. (canceled)

4. The measurement solution service providing system according to claim 1,
wherein the measurement data in the different formats have data lengths different from each other and include at least a measurement value in a measurement source as an item, and
the measurement data in the common format has a predetermined data length and includes at least identification information for specifying a user of the cloud computing system, identification information for specifying the base corresponding to the manufacturing site, identification information for specifying the measurement source, the measurement value in the measurement source, and measurement time information as items determined in advance.

5. The measurement solution service providing system according to claim 1,
wherein the measurement data in the common format is accumulated in the measurement database in a hierarchical structure of a logical tree form starting from the identification information for specifying the user of the cloud computing system, branching at the identification information for specifying the base corresponding to the manufacturing site and the identification information for specifying the measurement source, and ending at the measurement value in the measurement source and the measurement time information.

6. The measurement solution service providing system according to claim 1,
wherein the measurement data in the common format is subjected to the aggregation analysis processing by statistical process control analysis so that graph display, data display, and monitoring display on the viewer terminal are selectively available.

7. The measurement solution service providing system according to claim 6,
wherein the cloud computing system is further configured to constantly monitor a result of the aggregation analysis processing in the monitoring display, and perform alert notification by visual display in a case of exceeding a predetermined threshold.

8. The measurement solution service providing system according to claim 6,
wherein the cloud computing system is further configured to constantly monitor a result of the aggregation analysis processing in the monitoring display, and perform preliminary alert notification by visual display in a case of exceeding an approaching threshold to a critical threshold determined in advance.

9. The measurement solution service providing system according to claim 1,
wherein each of the plurality of measurement sources includes a measuring instrument,
the cloud computing system is a SaaS type cloud,
the IoT relay device is an IoT gateway, and
the communication network is an IP network.

10. A measurement solution service providing method comprising:
by each of a plurality of IoT relay devices arranged in respective bases, processing;
collecting measurement data in different formats transmitted from a plurality of measurement sources arranged in a distributed manner in each process in a base corresponding to a manufacturing site and measuring a quality status in each process,
converting the collected measurement data in the different formats into measurement data in a common format, and
transmitting the measurement data in the common format via a communication network for requesting to process the converted measurement data in the common format, and
by a cloud computing system, processing;
receiving the measurement data in the common format transmitted from each of the plurality of IoT relay devices and performing accumulation processing in a hierarchical structure in a measurement database,
performing aggregation analysis processing on the measurement data in the common format subjected to the accumulation processing for each integration target, and
performing display processing on a result of the aggregation analysis processing of the measurement data in the common format and transmitting a display processing result to a viewer terminal in response to a display request from the viewer terminal,
wherein at least one of the plurality of measurement sources includes a measurement data input device displaying a screen for inputting an actual measured value by a stand-alone measuring instrument as measurement data;
the screen of the measurement data input device includes:
a reference value display portion in which a predetermined reference value is displayed,
a measurement data display portion in which a candidate of the actual measured value is displayed with a position of at least a least significant digit in a blank state, and
a numerical value selection portion in which a numerical value at least corresponding to the least significant digit in a difference between the reference value and the actual measured value is displayed so as to be selectable and designatable from a numerical value display array, and
the measurement data input device processes;
displaying a numerical value corresponding to addition of the numerical value at least corresponding to the least significant digit designated by the numerical value selection portion in the screen and the reference value in the digit position in the blank state in the measurement data display portion, and
transmitting all digits of the actual measured value displayed in the measurement data display portion to the IoT relay device as the measurement data in the different formats upon a confirmation instruction by a measurement worker.

11. A measurement solution service providing method comprising:
by each of a plurality of IoT relay devices arranged in respective bases, processing;
collecting measurement data in different formats transmitted from a plurality of measurement sources arranged in a distributed manner in each process in a base corresponding to a manufacturing site and measuring a quality status in each process,
converting the collected measurement data in the different formats into measurement data in a common format, and
transmitting the measurement data in the common format via a communication network for requesting to process the converted measurement data in the common format, and
by a cloud computing system, processing;
receiving the measurement data in the common format transmitted from each of the plurality of IoT relay devices and performing accumulation processing in a hierarchical structure in a measurement database,
performing aggregation analysis processing on the measurement data in the common format subjected to the accumulation processing for each integration target, and
performing display processing on a result of the aggregation analysis processing of the measurement data in the common format and transmitting a display processing result to a viewer terminal in response to a display request from the viewer terminal,
wherein at least one of the plurality of measurement sources includes a measurement data input device displaying a screen for inputting an actual measured value by a stand-alone measuring instrument as measurement data;
the screen of the measurement data input device includes:
a reference value display portion in which a predetermined reference value is displayed,
a measurement data display portion in which a candidate of the actual measured value is displayed with a position of at least a least significant digit in a blank state, and
a numerical value selection portion in which a numerical value corresponding to a different portion between the reference value and the actual measured value is displayed so as to be selectable and designatable from a numerical value display array, and
the measurement data input device processes;
displaying a numerical value designated by the numerical value selection portion in the screen in the digit position in the blank state in the measurement data display portion, and
transmitting all digits of the actual measured value displayed in the measurement data display portion to the IoT relay device as the measurement data in the different formats upon a confirmation instruction by a measurement worker.

12. (canceled)

13. The measurement solution service providing method according to claim 10,
wherein the measurement data in the different formats have data lengths different from each other and include at least a measurement value in the measurement source as an item, and
the measurement data in the common format has a predetermined data length and includes at least identification information for specifying a user of the cloud computing system, identification information for specifying the base corresponding to the manufacturing site, identification information for specifying the measurement source, the measurement value in the measurement source, and measurement time information as items determined in advance.

14. The measurement solution service providing method according to claim 10,
wherein the measurement data in the common format is accumulated in the measurement database in a hierarchical structure of a logical tree form starting from the identification information for specifying the user of the cloud computing system, branching at the identification information for specifying the base corresponding to the manufacturing site and the identification information for specifying the measurement source, and ending at the measurement value in the measurement source and the measurement time information.

15. The measurement solution service providing method according to claim 10,
wherein the measurement data in the common format is subjected to the aggregation analysis processing by statistical process control analysis so that graph display, data display, and monitoring display on the viewer terminal are selectively available.

16. The measurement solution service providing method according to claim 15,
wherein the cloud computing system further includes constantly monitoring a result of the aggregation analysis processing in the monitoring display, and performing alert notification by visual display in a case of exceeding a predetermined threshold.

17. The measurement solution service providing method according to claim 15,
wherein the cloud computing system further includes constantly monitoring a result of the aggregation analysis processing in the monitoring display, and performing preliminary alert notification by visual display in a case of exceeding an approaching threshold to a critical threshold determined in advance.

18. A measurement solution service providing system comprising:
a plurality of relay devices arranged in respective bases serving as IoT gateways, each configured to:
collect measurement data transmitted from a plurality of measurement sources, and
transmit the measurement data via a communication network for requesting to process the collected measurement data, and
a cloud computing system configured to:
receive the measurement data transmitted from each of the plurality of relay devices and performing accumulation processing in a hierarchical structure in a measurement database,
perform aggregation analysis processing on the measurement data subjected to the accumulation processing for each integration target, and
perform display processing on a result of the aggregation analysis processing of the measurement data and transmitting a display processing result in response to a display request,
wherein at least one of the plurality of measurement sources includes a measurement data input device displaying a screen for inputting an actual measured value by a stand-alone measuring instrument as measurement data;
the screen of the measurement data input device includes:
a reference value display portion in which a predetermined reference value is displayed, a measurement data display portion in which a candidate of the actual measured value is displayed with a position of at least a least significant digit in a blank state, and
a numerical value selection portion in which a numerical value at least corresponding to the least significant digit in a difference between the reference value and the actual measured value is displayed so as to be selectable and designatable from a numerical value display array, and
the measurement data input device includes a processor configured to:
display a numerical value corresponding to addition of the numerical value at least corresponding to the least significant digit designated by the numerical value selection portion in the screen and the reference value in the digit position in the blank state in the measurement data display portion, and
transmit all digits of the actual measured value displayed in the measurement data display portion to the relay device as the measurement data upon a confirmation instruction by a measurement worker.

19. A measurement solution service providing system comprising:
a plurality of relay devices arranged in respective bases serving as IoT gateways, each configured to:
collect measurement data transmitted from a plurality of measurement sources, and
transmit the measurement data via a communication network for requesting to process the collected measurement data, and
a cloud computing system configured to:
receive the measurement data transmitted from each of the plurality of relay devices and performing accumulation processing in a hierarchical structure in a measurement database,
perform aggregation analysis processing on the measurement data subjected to the accumulation processing for each integration target, and
perform display processing on a result of the aggregation analysis processing of the measurement data and transmitting a display processing result in response to a display request,
wherein at least one of the plurality of measurement sources includes a measurement data input device displaying a screen for inputting an actual measured value by a stand-alone measuring instrument as measurement data;
the screen of the measurement data input device includes:
a reference value display portion in which a predetermined reference value is displayed,
a measurement data display portion in which a candidate of the actual measured value is displayed with a position of at least a least significant digit in a blank state, and
a numerical value selection portion in which a numerical value corresponding to a different portion between the reference value and the actual measured value is displayed so as to be selectable and designatable from a numerical value display array, and
the measurement data input device includes a processor configured to:
display a numerical value designated by the numerical value selection portion in the screen in the digit position in the blank state in the measurement data display portion, and
transmit all digits of the actual measured value displayed in the measurement data display portion to the relay device as the measurement data upon a confirmation instruction by a measurement worker.

20. A measurement solution service providing method comprising:
by each of a plurality of relay devices arranged in respective bases serving as IoT gateways, processing;
collecting measurement data transmitted from a plurality of measurement sources, and
transmitting the measurement data via a communication network for requesting to process the collected measurement data, and
by a cloud computing system, processing;
receiving the measurement data transmitted from each of the plurality of relay devices and performing accumulation processing in a hierarchical structure in a measurement database,
performing aggregation analysis processing on the measurement data subjected to the accumulation processing for each integration target, and
performing display processing on a result of the aggregation analysis processing of the measurement data and transmitting a display processing result in response to a display request,
wherein at least one of the plurality of measurement sources includes a measurement data input device displaying a screen for inputting an actual measured value by a stand-alone measuring instrument as measurement data;
the screen of the measurement data input device includes:
a reference value display portion in which a predetermined reference value is displayed,
a measurement data display portion in which a candidate of the actual measured value is displayed with a position of at least a least significant digit in a blank state, and
a numerical value selection portion in which a numerical value at least corresponding to the least significant digit in a difference between the reference value and the actual measured value is displayed so as to be selectable and designatable from a numerical value display array, and
the measurement data input device processes:
displaying a numerical value corresponding to addition of the numerical value at least corresponding to the least significant digit designated by the numerical value selection portion in the screen and the reference value in the digit position in the blank state in the measurement data display portion, and
transmitting all digits of the actual measured value displayed in the measurement data display portion to the relay device as the measurement data upon a confirmation instruction by a measurement worker.

21. A measurement solution service providing method comprising:
by each of a plurality of relay devices arranged in respective bases serving as IoT gateways, processing;
collecting measurement data transmitted from a plurality of measurement sources, and
transmitting the measurement data via a communication network for requesting to process the collected measurement data, and
by a cloud computing system, processing;
receiving the measurement data transmitted from each of the plurality of relay devices and performing accumulation processing in a hierarchical structure in a measurement database,
performing aggregation analysis processing on the measurement data subjected to the accumulation processing for each integration target, and
performing display processing on a result of the aggregation analysis processing of the measurement data and transmitting a display processing result in response to a display request,
wherein at least one of the plurality of measurement sources includes a measurement data input device displaying a screen for inputting an actual measured value by a stand-alone measuring instrument as measurement data;
the screen of the measurement data input device includes:
a reference value display portion in which a predetermined reference value is displayed,
a measurement data display portion in which a candidate of the actual measured value is displayed with a position of at least a least significant digit in a blank state, and
a numerical value selection portion in which a numerical value corresponding to a different portion between the reference value and the actual measured value is displayed so as to be selectable and designatable from a numerical value display array, and
the measurement data input device processes:
displaying a numerical value designated by the numerical value selection portion in the screen in the digit position in the blank state in the measurement data display portion, and
transmitting all digits of the actual measured value displayed in the measurement data display portion to the relay device as the measurement data upon a confirmation instruction by a measurement worker.

22. A measurement data input device displaying a screen for inputting an actual measured value by a measuring instrument as measurement data,
wherein the screen includes:
a reference value display portion in which a predetermined reference value is displayed,
a measurement data display portion in which a candidate of the actual measured value is displayed with a position of at least a least significant digit in a blank state, and
a numerical value selection portion in which a numerical value at least corresponding to the least significant digit in a difference between the reference value and the actual measured value is displayed so as to be selectable and designatable from a numerical value display array, and
the measurement data input device includes a processor configured to:
display a numerical value corresponding to addition of the numerical value at least corresponding to the least significant digit designated by the numerical value selection portion in the screen and the reference value in the digit position in the blank state in the measurement data display portion, and
output all digits of the actual measured value displayed in the measurement data display portion as the measurement data upon a confirmation instruction by a measurement worker.

23. A measurement data input device displaying a screen for inputting an actual measured value by a measuring instrument as measurement data,
wherein the screen includes:
a reference value display portion in which a predetermined reference value is displayed,
a measurement data display portion in which a candidate of the actual measured value is displayed with a position of at least a least significant digit in a blank state, and
a numerical value selection portion in which a numerical value corresponding to a different portion between the reference value and the actual measured value is displayed so as to be selectable and designatable from a numerical value display array, and
the measurement data input device includes a processor configured to:
display a numerical value designated by the numerical value selection portion in the screen in the digit position in the blank state in the measurement data display portion, and
output all digits of the actual measured value displayed in the measurement data display portion as the measurement data upon a confirmation instruction by a measurement worker.
